(19) United States
(12) Patent Application Publication
(10) Pub. No.: US 2026/0185496 A1
(43) Pub. Date: Jul. 2, 2026

(54) GASEOUS FUEL ENGINE SYSTEM AND METHOD UTILIZING SCALLOPED PISTON FOR HASTENED FUEL-AIR MIXING

(71) Applicant: Caterpillar Inc., Peoria, IL (US)

(72) Inventor: Bobby John, Peoria, IL (US)

(73) Assignee: Caterpillar Inc., Peoria, IL (US)

(21) Appl. No.: 19/007,703

(22) Filed: Jan. 2, 2025

(51) Int. Cl. F02M 21/02; F02B 23/00

(52) U.S. Cl. CPC F02M 21/0248; F02B 23/00; F02M 21/0206

(57) ABSTRACT

A gaseous fuel internal combustion engine includes a piston having a combustion face forming a piston rim surface and reciprocated in a cylinder in an engine housing. The engine also includes a gaseous fuel injector supported in a cylinder head of the engine housing. The combustion face includes an injection-impingement surface extending along the piston rim surface and spaced radially outward of a piston center axis, and a plurality of fuel-dispersal scallops. The scallops define a plurality of fuel paths advancing away from the injection-impingement surface and configured to disperse gaseous fuel in the cylinder so as to hasten mixing with air. The gaseous fuel may be a gaseous hydrogen fuel. Related methodology is also disclosed.

### TECHNICAL FIELD

The present disclosure relates generally to a gaseous fuel internal combustion engine, and more particularly to enhanced mixing of a gaseous fuel with air in-cylinder utilizing fuel-dispersal scallops of a piston.

### BACKGROUND

Internal combustion engines are widely used throughout the world for purposes ranging from vehicle propulsion to operation of pumps and compressors, to generation of electrical power. Typical internal combustion engines employ a plurality of pistons that reciprocate in cylinder bores to rotate a crankshaft in response to a controlled combustion reaction producing a rapid pressure and temperature rise to drive the pistons. For decades engineers have experimented with a wide variety of different fuels, various exhaust treatment apparatuses and technologies, and different operating strategies in efforts to improve engine operation, reliability, and performance.

In recent years considerable engineering resources have been directed at developing pistons optimized for various applications. Depending upon engine type, a piston is commonly formed with a specified combustion face geometry intended to interact with flows of fuel, air, and/or exhaust during operation to various ends including optimizing emissions and/or efficiency, to mitigate or otherwise control in-cylinder temperatures and/or mechanical wear or corrosion, and for various other purposes. It has been observed that oftentimes seemingly quite minor changes to piston geometry can have outsized effects upon engine operation and performance, and the results of toggling any one variable respecting piston geometry can often be quite unpredictable. Depending upon fuel type and a great many different operating parameters and different engine applications, optimized piston designs can have widely varying geometries. One known piston having a unique combustion face design is set forth in U.S. Pat. No. 9,670,829 to Bowing et al.

Compounding challenges around designing pistons for various different applications are recent commercial motivations to utilize alternative fuels. Many different piston designs for diesel engines, gasoline engines, and natural gas engines have been proposed. More recently, efforts at designing pistons optimized for hydrogen have begun in earnest. Combustion of hydrogen in an internal combustion engine brings many new challenges, as hydrogen tends to be easily ignited, and has a very rapid flame speed compared to certain traditional fuels, among other differences. While hydrogen engines and pistons optimized for combusting hydrogen have been proposed and some are now commercially available, many obstacles and opportunities for improvement and development of alternative strategies remain.

### SUMMARY

In one aspect, a gaseous fuel internal combustion engine includes an engine housing having a cylinder block forming a cylinder, and a cylinder head attached to the cylinder block. The engine further includes a piston having a combustion face with a piston rim surface, and defining a piston center axis. The engine also includes a gaseous fuel injector supported in the cylinder head. The combustion face includes an injection-impingement surface extending along the piston rim surface and spaced radially outward of the piston center axis, and a plurality of fuel-dispersal scallops defining a plurality of fuel paths advancing in directions away from the injection-impingement surface toward the piston rim surface.

In another aspect, a piston for a gaseous fuel engine includes a piston crown defining a piston center axis, and including a first axial end forming a combustion face having a piston rim surface, and a second axial end. The combustion face includes an injection-impingement surface extending along the piston rim surface and sloped radially inward and axially downward relative to the piston center axis, and a plurality of fuel-dispersal scallops defining a plurality of fuel paths advancing in directions away from the injection-impingement surface toward the piston rim surface.

In still another aspect, a method of operating a gaseous fuel internal combustion engine includes injecting a gaseous fuel into a cylinder in an internal combustion engine, impinging the gaseous fuel upon an injection-impingement surface of a combustion face of a piston reciprocated in the cylinder, and advancing the gaseous fuel across the piston by way of a plurality of fuel-dispersal scallops arranged in a combustion bowl of the combustion face. The method further includes dispersing the gaseous fuel in the cylinder by way of the plurality of fuel-dispersal scallops so as to hasten mixing of the gaseous fuel with air in the cylinder, and combusting the gaseous fuel and air in the cylinder.

### BRIEF DESCRIPTION OF DRAWINGS

FIG. 1 is a diagrammatic view of a gaseous fuel internal combustion engine system, according to one embodiment;

FIG. 2 is a diagrammatic view of a piston, according to one embodiment;

FIG. 3 is an elevational view of the piston as in FIG. 2;

FIG. 4 is an elevational view of a piston according to another embodiment;

FIG. 5 is a side diagrammatic view showing fuel injection and dispersal according to one embodiment; and

FIG. 6 is a top view showing fuel injection and dispersal, according to one embodiment.

### DETAILED DESCRIPTION

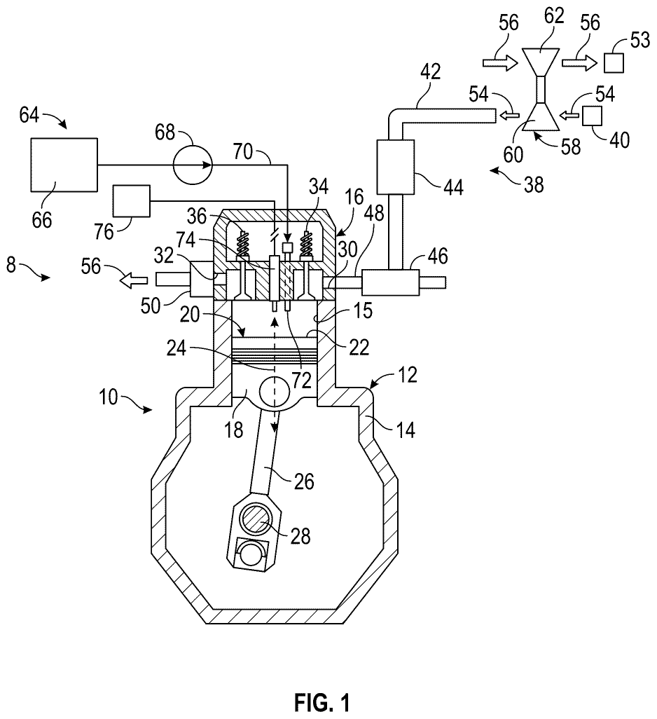

Referring to FIG. 1, there is shown a gaseous fuel internal combustion engine system 8, according to one embodiment. Engine system 8 includes a gaseous fuel internal combustion engine 10 having an engine housing 12. Engine housing 12 includes a cylinder block 14 forming a cylinder 15, and a cylinder head 16 attached to cylinder block 14. Cylinder 15 may be one of a plurality of cylinders of any number and in any suitable arrangement such as an in-line patten, a V-pattern, or still another. A piston 18 is movable in cylinder 15 between a top-dead-center position and a bottom-dead-center position, typically in a four-stroke engine cycle.

Piston 18 includes a combustion face 20 having a planar piston rim surface 22, and defines a piston center axis 24. Piston 18 is coupled to a connecting rod 26 in turn coupled to a crankshaft 28 to rotate crankshaft 28 in response to reciprocation of piston 18 in cylinder 15. Engine system 8 can be applied in any known application, including operating a driveline in a land vehicle or a marine vessel, operating a pump, a compressor, or an electrical generator to name a few examples.

An intake port 30 is formed in cylinder head 16 as well as an exhaust port 32. An intake valve 34, typically one of two intake valves, is movable to open and close fluid communication between intake port 30 and cylinder 15. An exhaust valve 36, typically one of two exhaust valves, is movable to open and close fluid communication between exhaust port 32 and cylinder 15. Engine system 8 also includes an air system 38. Air system 38 includes a fresh air inlet 40, and an intake conduit extending from fresh air inlet 40 to an intake manifold 46 typically by way of a charge air cooler 44. An intake runner 48 extends to intake port 30. Additional intake runners may be provided extending to additional cylinders in engine 10 not shown in FIG. 1. Engine 10 also includes an exhaust manifold 50 and an exhaust conduit 52 extending from exhaust manifold 50 to an exhaust outlet 53. Incoming intake air is shown at 54 in FIG. 1 and outgoing exhaust from combustion is shown at 56. Air system 38 may also include a turbocharger 58 having a compressor 60 pressurizing the intake air, and rotated by way of extracting energy from exhaust by way of a turbine 62.

Engine system 8 also includes a fuel system 64. Fuel system 64 includes a fuel supply 66, at least one fuel pump 68, and a fuel supply conduit 70 extending from fuel pump 68 to a fuel injector 72. Fuel supply 66 may contain a gaseous fuel, such as in a pressurized state. Embodiments of the present disclosure also contemplate fuel stored in a cryogenically liquefied state and/or fuel supplied by way of a gas line or the like (so-called “line gas”). Also in a practical implementation, the gaseous fuel may include a gaseous hydrogen fuel such as gaseous molecular hydrogen. Engine system 8 may also be configured to operate on a blend of gaseous molecular hydrogen and a gaseous hydrocarbon fuel such as natural gas, methane, ethane, propane or still others. In further implementations engine system 8 could be operated on substantially pure gaseous molecular hydrogen, solely a hydrocarbon gaseous fuel, or blends of hydrogen and hydrocarbon potentially supplied at a variable blend ratio. A gaseous hydrogen fuel as contemplated therein means a gaseous fuel where gaseous molecular hydrogen predominates by volume. It should be appreciated the present disclosure is not limited with respect to gaseous fuel type or composition.

Fuel injector 72 is shown arranged as a direct injector for directly injecting gaseous fuel into cylinder 15. Fuel injector 72 may be electrically actuated, such as solenoid actuated, and injects gaseous fuel at a desired injection timing. In some embodiments the injection timing may be prior to an intake valve closing timing in an engine cycle as further discussed herein. In other embodiments, fuel injector 72 could be configured as a port fuel injector arranged to inject gaseous fuel into intake port 30. Engine system 8 also includes a sparkplug 74 forming a spark gap in cylinder 15 for generating an electrical spark to ignite a mixture of gaseous fuel and air in cylinder 15. Sparkplug 74 may be electrically connected to and both energized and controlled by an electronic control unit or ECU 76. Sparkplug 74 might include an open sparkplug or a prechamber sparkplug, for example. Prechamber ignition strategies where a dedicated feed of a fuel is fed to a prechamber fluidly connect to cylinder 15 are also within the scope of the present disclosure.

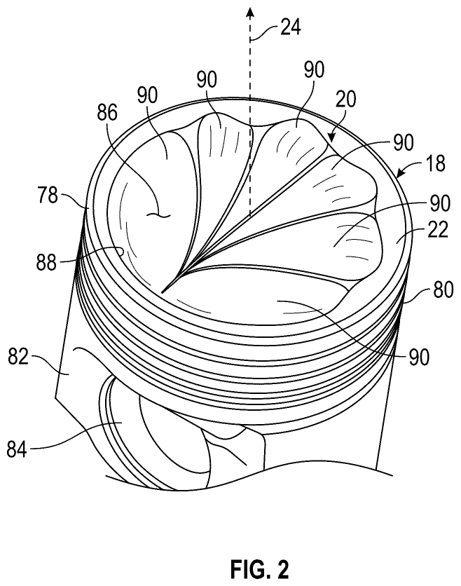

Referring also now to FIG. 2, there are shown additional features of piston 18. Combustion face 20 includes an injection-impingement surface 88 extending along piston rim surface 22 and spaced radially outward of piston center axis 24. Piston 18 also includes a piston crown 78 having a crown outer surface 80, and a piston skirt 82 forming a wrist pin bore 84, attached to piston crown 78. Combustion face 20 forms a combustion bowl 86.

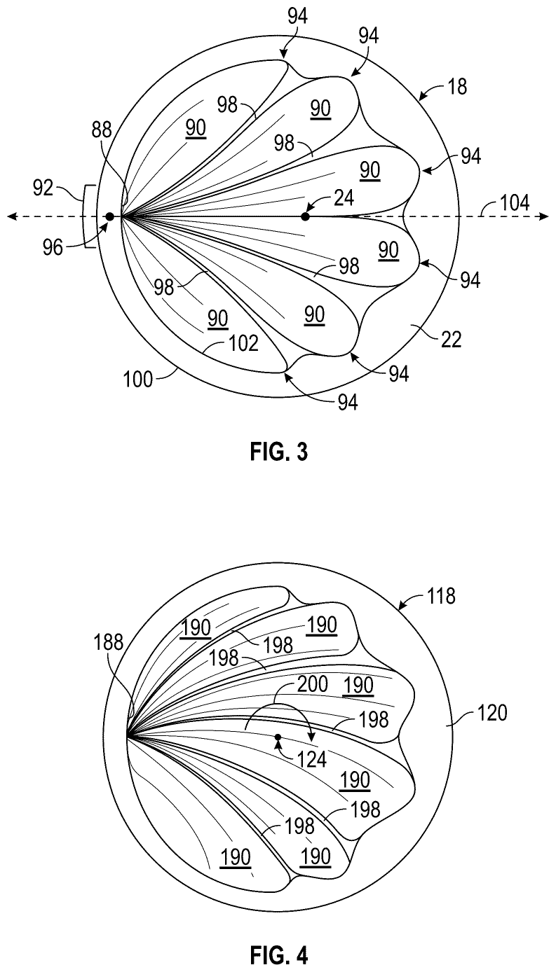

Referring also to FIG. 3, injection-impingement surface 88 may be sloped radially inward, and axially downward, into the page in FIG. 3, relative to piston center axis 24. Combustion face 20 further includes a plurality of fuel-dispersal scallops 90 defining a plurality of fuel paths advancing in directions away from injection-impingement surface 88 toward piston rim surface 22. Fuel-dispersal scallops 90 may be arranged so as to define a divergent pattern of the plurality of fuel paths, the significance of which will be further apparent from the following description. It can also be seen from FIG. 3 that piston rim surface 22 extends from injection-impingement surface 88 to piston crown outer surface 80. Injection-impingement surface 88 and fuel-dispersal scallops 90 may be within combustion bowl 86.

Also in a practical implementation, injection-impingement surface 88 is arranged at a first location circumferentially around piston center axis 24. Injection-impingement surface 88 may have a circumferential extent around piston center axis 24 of a few degrees, for example, defining a circular arc length of 20 degrees or less, or 10 degrees or less. The first location is shown approximately at numeral 92 in FIG. 3. Fuel dispersal scallops 90 may extend to a plurality of different fuel exit locations 94 circumferentially around piston center axis 24. FIG. 3 also illustrates a fuel axis 96, an approximate center axis of a fuel spray plume injected by way of fuel injector 72 for impingement upon fuel-impingement surface 88. In an embodiment, first location 92 may include a 9 o'clock location and the plurality of different exit locations 94 may include a plurality of exit locations between a 12 o'clock location and a 6 o'clock location. Thus, exit locations 94 may be biased in distribution to one half of combustion face 20, potentially all being located in one half of combustion face 20.

Focusing still on FIG. 3, combustion face 20 may further form a plurality of ridges 98 in an alternating arrangement with fuel-dispersal scallops 90. It can be appreciated that ridges 98 may extend generally across combustion face 20 and form convex raised regions between concave fuel-dispersal scallops 90. A total number of fuel-dispersal scallops 90 may be from 2 to 8 in some embodiments. In the illustrated embodiment of FIG. 3 a total number of fuel-dispersal scallops 90 is exactly 6. FIG. 3 also shows a plane edge-on at numeral 104. Plane 104 includes piston center axis 24 and extends in and out of the page in FIG. 3. Fuel-dispersal scallops 90 may be arranged symmetrically about plane 104, so as to define mirror images as depicted in FIG. 3.

FIG. 3 also shows an outer peripheral edge 100 of piston rim surface 22. Outer peripheral edge 100 may have a circular shape centered on piston center axis 24. Piston rim surface 22 may also include an inner peripheral edge 102. Inner peripheral edge 102 may have a contour defining a plurality of peaks corresponding to locations of ridges 98 circumferentially around piston center axis 24, and a plurality of valleys forming exit locations 94 of fuel-dispersal scallops 90. Each of fuel-dispersal scallops 90 may also include a diameter enlarged in the respective direction away from injection-impingement surface 88. For example, from FIG. 3 it can be seen that all of fuel-dispersal scallops 90 at least initially enlarge in diameter moving in directions away from injection-impingement surface 88. It should be appreciated that various extensions and alternatives are contemplated herein, including fuel-dispersal scallops that are not symmetric about a plane, fuel-dispersal scallops that have substantially uniform diameters, narrowing diameters away from an injection-impingement surface, and still other variations.

In many engine systems, a swirl of incoming intake air may be produced based on the geometry of an intake port and/or intake valves. Referring also now to FIG. 4, there is shown a piston 118 configured to cooperate with the swirling of incoming intake air. Piston 118 includes a combustion face 120 and defines a piston center axis 124. Combustion face 120 also forms an injection-impingement surface 188, and a plurality of fuel-dispersal scallops 190 extending across piston 118 away from injection-impingement surface 188. Injection-impingement surface 188 may be configured generally analogously to injection-impingement surface 88 discussed above. Fuel-dispersal scallops 190, in an alternating arrangement with ridges 198, may differ from the embodiment discussed above at least respecting a curvature thereof. It can be seen from FIG. 4 that fuel-dispersal scallops 190 generally fan out from injection-impingement surface 88, but curve, generally defining a swirl direction 200 circumferentially around piston center axis 124. Gaseous fuel injected and impinged upon injection-impingement surface 188 may have a tendency to travel in curving plumes along and through fuel-dispersal scallops 190, in a direction circumferentially around piston center axis 124 generally the same as a swirling flow of incoming pressurized intake air.

### INDUSTRIAL APPLICABILITY

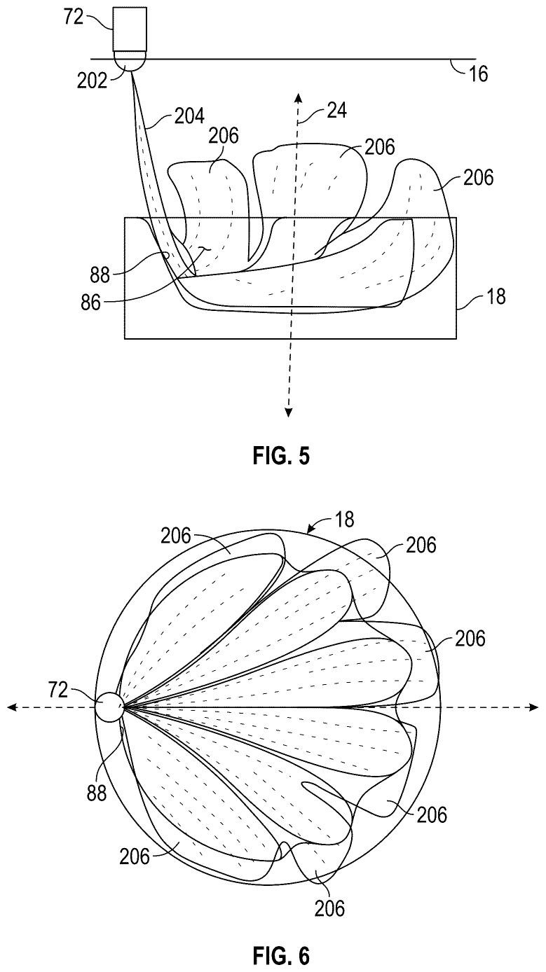

Referring also now to FIGS. 5 and 6, there are shown diagrammatic illustrations representing example gaseous fuel flow in cylinder 15 utilizing the unique geometry of piston 18. FIG. 5 also shows fuel injector 72 including a fuel outlet 202 defining a fuel spray path that will be understood to extend outwardly of fuel injector 72 and downwardly in a direction of piston 18. In FIGS. 5 and 6 piston 18 and injected fuel are shown approximately as they might appear shortly after injecting gaseous fuel, such as before an intake valve closing timing in an engine cycle to take advantage of movement of the incoming intake air. Numeral 204 shows an outgoing fuel spray from outlet 202, impinged upon injection impingement surface 88, and redirected to form fuel spray plumes 206 by way of fuel-dispersal scallops 90.

FIG. 6 illustrates a top view where it can be seen that the impinged fuel changes direction based on impingement upon injection-impingement surface 88, and flows spreading across piston 18 in fuel plumes 206, generally representing fuel paths in a divergent pattern as discussed herein. It can also be noted from FIGS. 5 and 6 that fuel spray plumes 206 may actually separate so that regions less rich in fuel, potentially containing substantially only air, are formed between fuel plumes 206. It is believed that the dispersing of gaseous fuel by way of fuel-dispersal scallops 90 hastens mixing of gaseous fuel with air in the cylinder. With the gaseous fuel and air mixed, sparkplug 74 can be energized to spark-ignite the mixture of gaseous fuel and air at a desired ignition timing. Those skilled in the art will appreciate various advantages respecting enhanced and hastened mixing of fuel and air in a gaseous fuel internal combustion engine, in particular operating on gaseous hydrogen fuel. Improved mixing of gaseous hydrogen fuel and air can reduce various forms of undesired combustion, including knock and/or errors in combustion phasing, and can improve fuel efficiency as well as limit excess production of oxides of nitrogen, for example.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A gaseous fuel internal combustion engine comprising:
an engine housing including a cylinder block forming a cylinder, and a cylinder head attached to the cylinder block;
a piston including a combustion face having a piston rim surface, and defining a piston center axis;
a gaseous fuel injector supported in the cylinder head; and
the combustion face including an injection-impingement surface extending along the piston rim surface and spaced radially outward of the piston center axis, and a plurality of fuel-dispersal scallops defining a plurality of fuel paths advancing in directions away from the injection-impingement surface toward the piston rim surface.

2. The engine of claim 1 wherein the injection-impingement surface is sloped radially inward and axially downward relative to the piston center axis, and the plurality of fuel-dispersion scallops are arranged so as to define a divergent pattern of the plurality of fuel paths.

3. The engine of claim 2 wherein:
the piston rim surface extends from the injection-impingement surface to a piston crown outer surface; and
the combustion face forms a combustion bowl and the injection-impingement surface and the plurality of fuel-dispersal scallops are within the combustion bowl.

4. The engine of claim 1 wherein the injection-impingement surface is arranged at a first location circumferentially around the piston center axis, and the plurality of fuel-dispersal scallops extend to a plurality of different exit locations circumferentially around the center axis.

5. The engine of claim 4 wherein the first location includes a 9 o'clock location, and the plurality of different exit locations are between a 12 o'clock location and a 6 o'clock location.

6. The engine of claim 4 wherein the fuel injector includes a fuel outlet defining a fuel spray path in circumferential alignment with the first location.

7. The engine of claim 1 wherein each of the plurality of fuel-dispersal scallops includes a diameter enlarged in the respective direction away from the injection-impingement surface, and a total number of the plurality of fuel-dispersal scallops is from 2 to 8.

8. The engine of claim 7 wherein the combustion face further forms a plurality of ridges in an alternating arrangement with the plurality of scallops.

9. A piston for a gaseous fuel engine comprising:
a piston crown defining a piston center axis, and including a first axial end forming a combustion face having a piston rim surface, and a second axial end; and
the combustion face including an injection-impingement surface extending along the piston rim surface and sloped radially inward and axially downward relative to the piston center axis, and a plurality of fuel-dispersal scallops defining a plurality of fuel paths advancing in directions away from the injection-impingement surface toward the piston rim surface.

10. The piston of claim 9 wherein the combustion face further forms a plurality of ridges in an alternating arrangement with the plurality of scallops.

11. The piston of claim 10 wherein the piston rim surface includes an outer peripheral edge, and an inner peripheral edge having a contour defining a plurality of peaks, and a plurality of valleys forming exit locations of the plurality of fuel-dispersal scallops.

12. The piston of claim 11 wherein the plurality of fuel-dispersal scallops are symmetric about a plane that includes the piston center axis.

13. The piston of claim 9 wherein the injection-impingement surface is arranged at a first location circumferentially around the piston center axis, and the plurality of fuel-dispersal scallops extend to a plurality of different exit locations circumferentially around the center axis.

14. The piston of claim 13 wherein the first location includes a 9 o'clock location, and the plurality of different exit locations are between a 12 o'clock location and a 6 o'clock location.

15. The piston of claim 9 wherein a total number of the plurality of fuel-dispersal scallops is from 2 to 8.

16. The piston of claim 9 wherein the plurality of fuel paths are arranged in a swirl pattern.

17. The piston of claim 9 wherein each of the plurality of fuel-dispersal scallops includes a diameter enlarged in the respective direction away from the injection-impingement surface.

18. A method of operating a gaseous fuel internal combustion engine comprising:
injecting a gaseous fuel into a cylinder in an internal combustion engine;
impinging the gaseous fuel upon an injection-impingement surface of a combustion face of a piston reciprocated in the cylinder;
advancing the gaseous fuel across the piston by way of a plurality of fuel-dispersal scallops arranged in a combustion bowl of the combustion face;
dispersing the gaseous fuel in the cylinder by way of the plurality of fuel-dispersal scallops so as to hasten mixing of the gaseous fuel with air in the cylinder; and
combusting the gaseous fuel and air in the cylinder.

19. The method of claim 18 wherein the injection-impingement surface is located radially outward relative to a piston center axis, and the plurality of fuel-dispersal scallops define a plurality of fuel paths advancing in directions forming a divergent pattern away from the injection-impingement surface.

20. The method of claim 18 wherein the directly injecting the gaseous fuel includes directly injecting a gaseous hydrogen fuel at an injection timing prior to an intake valve closing timing in an engine cycle.
